(19) United States
(12) Patent Application Publication
(10) Pub. No.: US 2019/0187248 A1
(43) Pub. Date: Jun. 20, 2019

(54) SPECIFIC DIFFERENTIAL PROPAGATION PHASE APPARATUS AND METHOD USING DUAL-POLARIZATION VARIABLES

(71) Applicant: KOREA INSTITUTE OF CIVIL ENGINEERING AND BUILDING TECHNOLOGY, Goyang-si (KR)

(72) Inventor: Sang Hun LIM, Goyang-si (KR)

(21) Appl. No.: 16/213,256

(22) Filed: Dec. 7, 2018

(30) Foreign Application Priority Data
Dec. 18, 2017 (KR) 10-2017-0174058

(51) Int. Cl. G01S 7/02

(52) U.S. Cl. CPC G01S 7/025; G01S 13/95

(57) ABSTRACT

Provided is an apparatus and a method for estimating a specific differential phase using dual-polarization variables. The apparatus includes: a memory for storing a specific differential phase estimation program for estimating a specific differential phase using the dual-polarization variable of an observation data received from a dual-polarization radar and a self-consistent calculation method; and a processor including: a horizontal attenuation calculation unit; a differential phase calculation unit; a cost function calculation unit; and a specific differential phase calculation unit.

### BACKGROUND OF THE INVENTION

### Field of the Invention

The present invention relates to an apparatus and a method for estimating a specific differential phase using dual-polarization variables, and more specifically, to an apparatus and a method for estimating a specific differential phase using dual-polarization variables, which can estimate a specific differential phase on the basis of a self-consistent method using dual-polarization variables.

### Background of the Related Art

A differential phase is a difference between horizontal and vertical propagation phases and is proportional to forward scattering characteristics of hydrometeor. It is general that a horizontal propagation phase shift is larger than a vertical propagation phase shift in a horizontally deflected hydrometeor such as raindrops.

In addition, in a non-meteorological echo, variation of a differential phase is absolutely greater than variation in precipitation due to a poor correlation between signals of horizontal polarization and vertical polarization.

Generally, a specific differential phase is calculated as a mean slope of range profiles measured across a path.

To measure a specific differential phase from a measured mean slope of range profiles, Golestani, et al. (1989) and Hubbert and Bringi (1995) used a filtering method. This method works well in a rainfall area, in which microphysical properties do not change abruptly like laminar flow type rainfall. However, the peak value of a specific differential phase is underestimated in an abrupt convective rainfall area, and the specific differential phase sometimes even has a negative value. It is known that this is misestimated, comparing with that the specific differential phase has a characteristic of increasing at all times.

In addition, since signals of an estimated specific differential phase change greatly, it may oscillate greatly even in an area showing a low rainfall rate (Wang and Chandrasekar 2009). Wang and Chandrasekar (2009) proposed an adaptive algorithm to reduce noise related to variation of a small segment and to reduce convenience of estimation in a large segment.

This method is configured to adjust a regression error through scaling for estimation of a specific differential phase. This method allows to obtain a specific differential phase having a comparatively improved peak value even in a weak rainfall area, as well as in a torrential area.

However, the method proposed by Wang and Chandrasekar (2009) is also based on a filtering method and is not effective in removing back scattering and solving the problem of negative value of the specific differential phase.

### SUMMARY OF THE INVENTION

Therefore, the present invention has been made in view of the above problems, and it is an object of the present invention to provide an apparatus and a method for estimating a specific differential phase using dual-polarization variables, which can estimate precipitation more accurately by estimating an optimum specific differential phase on the basis of a self-consistent method using dual-polarization variables, instead of the existing filtering method, on hydrometeor such as rainfall.

The technical problems of the present invention are not limited to those mentioned above, and unmentioned other technical problems may be clearly understood by those skilled in the art from the following descriptions.

To accomplish the above object, according to one aspect of the present invention, there is provided a specific differential phase estimation apparatus using dual-polarization variables, the apparatus comprising: a memory for storing a specific differential phase estimation program for estimating a specific differential phase using the dual-polarization variables of an observation data received from a dual-polarization radar and a self-consistent calculation method; and a processor including: a horizontal attenuation calculation unit for calculating a plurality of horizontal attenuations \hat{α}ₕ_{_}ᵢₖ(r) using an observed horizontal reflectivity Zₕ(r), an observed differential reflectivity Z_{dr}(r), and an observed differential phase ϕ_{dp}(r) received as observation data by executing the specific differential phase estimation program stored in the memory; a differential phase calculation unit for calculating (m×n) differential phases using the calculated (m×n) horizontal attenuations; a cost function calculation unit for calculating a cost function including a difference between each of the calculated (m×n) differential phases and the observed differential phase for each of the (m×n) differential phases; and a specific differential phase calculation unit for calculating a specific differential phase using a horizontal attenuation, corresponding to a minimum cost function among the calculated (m×n) cost functions, and a proportion variable corresponding to the minimum cost function, wherein the horizontal attenuation calculation unit calculates (m×n) horizontal attenuations \hat{α}ᵢₖ(r) considering m proportion variables γᵢ of a differential phase and a total horizontal attenuation, and n kappa variables k of the differential phase and a total differential attenuation.

The processor may further include a total differential phase calculation unit for calculating a difference of differential phase between a rainfall start point r₀ and a rainfall end point rₘ from the observed differential phase as a total differential phase Δϕ_{dp}(r), and the horizontal attenuation calculation unit may calculate the (m×n) horizontal attenuations using the observed horizontal reflectivity, the observed differential reflectivity, and the calculated total differential phase.

The horizontal attenuation calculation unit may calculate the horizontal attenuations using a following equation.

$${\hat{α}}_{h \_ ik} ( r ) = \frac{{{[ {Z}_{h}^{′} ( r ) ]}^{b} [ {Z}_{dr}^{′} ( r ) ]}^{c} ( {10}^{0.1 \cdot {γ}_{i} {μ}_{k} \cdot {Δφ}_{dp} ( r )} - 1 )}{{I}_{h} ( {r}_{0} ; {r}_{m} ) - ( {10}^{0.1 \cdot {γ}_{i} {μ}_{k} \cdot {Δφ}_{dp} ( r )} - 1 ) {I}_{h} ( r ; {r}_{m} )} ;$$

$${I}_{h} ( {r}_{0} ; {r}_{m} ) = 0.46 \cdot {μ}_{k} {\int }_{{r}_{0}}^{{r}_{m}} {{[ {Z}_{h}^{′} ( r ) ]}^{b} [ {Z}_{dr}^{′} ( r ) ]}^{c} dr$$

$${μ}_{k} = f ( b , c ) = b + {k}_{k} \cdot c$$

Here, i and k are indexes of the m proportion variables γᵢ and n proportion variables μₖ respectively, \hat{α}ₕ_{_}ᵢₖ(r) is a horizontal attenuation calculated for indexes i and k among (m×n) proportion variables, Z′ₕ(r) is an observed horizontal reflectivity, Z′_{dr}(r) is an observed differential reflectivity, ϕ_{dp}(r) is an observed differential phase, and Δϕ_{dp}(r) is a total differential phase, γᵢ is a proportion variable of a differential phase and a total horizontal attenuation, μₖ is a proportion variable determined by a kappa variable and a constant according to a radar frequency, r₀ is a rainfall start point, and rₘ is a rainfall end point.

The differential phase calculation unit may calculate the differential phase using a following equation.

$${φ}_{dp}^{c \_ ik} ( r ) = 2 {\int }_{{r}_{0}}^{r} \frac{{\hat{α}}_{h \_ ik} ( r )}{{γ}_{i}} ds ; {γ}_{m i n} \leq {γ}_{i} \leq {γ}_{ma x}$$

Here, i and k are indexes of the m proportion variables and n proportion variables respectively, ϕ_{dp}^{c}^{_}^{ik}(r) is a differential phase calculated at indexes i and k among the (m×n) proportion variables, and γᵢ is an i-th proportion variable among the m proportion variables.

The cost function calculation unit may calculate the (m×n) cost functions from a sum of results of obtaining a difference between each of the calculated (m×n) differential phases and the observed differential phase at every observation distance.

The cost function calculation unit may calculate a cost function using a following equation.

$${x}_{i , k} = \frac{1}{N} {\sum }_{j = 1}^{N} \vert \frac{( {φ}_{dp} ( {r}_{j} ) - {φ}_{dp}^{{c}_{1 k}} ( {r}_{j} ) ) \cdot {φ}_{dp} ( {r}_{j} )}{{Δφ}_{dp}} \vert$$

Here, i and k are indexes of the m proportion variables and n proportion variables respectively, X_{i,k} is a cost function at indexes i and k among the (m×n) proportion variables, j is an index of an observation distance, γⱼ is an observation distance, ϕ_{dp}(rⱼ) is a differential phase observed at j, and ϕ_{dp}^{c}^{ᵢₖ}(rⱼ) is a differential phase calculated at j.

The specific differential phase calculation unit may calculate the specific differential phase using a horizontal attenuation corresponding to the minimum cost function and a proportion variable of the differential phase and the total horizontal attenuation corresponding to the minimum cost function.

Meanwhile, according to another embodiment of the present invention, there is provided a method of estimating a specific differential phase using specific differential variables of a specific differential phase estimation apparatus, the method comprising the steps of: (A) calculating a plurality of horizontal attenuations using an observed horizontal reflectivity Zₕ(r), an observed differential reflectivity Z_{dr}(r), and an observed differential phase ϕ_{dp}(r) inputted as observation data of a dual-polarization radar; (B) calculating (m×n) differential phases using the calculated (m×n) horizontal attenuations; (C) calculating a cost function including a difference between each of the calculated (m×n) differential phases and the observed differential phase for each of the (m×n) differential phases; and (D) calculating a specific differential phase using a horizontal attenuation, corresponding to a minimum cost function among the calculated (m×n) cost functions, and a proportion variable corresponding to the minimum cost function, wherein step (A) calculates (m×n) horizontal attenuations \hat{α}ₕ_{_}ᵢₖ(r) considering m proportion variables γᵢ of a differential phase and a total horizontal attenuation, and n kappa variables k of the differential phase and a total differential attenuation.

Step (A) may include the steps of: (A1) receiving the observed horizontal reflectivity, the observed differential reflectivity, and the observed differential phase as observation data of the dual-polarization radar; (A2) calculating a difference of differential phase between a rainfall start point r₀ and a rainfall end point rₘ from the observed differential phase as a total differential phase Δϕ_{dp}(r); and (A3) calculating the (m×n) horizontal attenuations using the observed horizontal reflectivity, the observed differential reflectivity, and the total differential phase.

Step (A3) may calculate the horizontal attenuations using a following equation.

$${\hat{α}}_{h \_ ik} ( r ) = \frac{{{[ {Z}_{h}^{′} ( r ) ]}^{b} [ {Z}_{dr}^{′} ( r ) ]}^{c} ( {10}^{0.1 \cdot {γ}_{i} {μ}_{k} \cdot {Δφ}_{dp} ( r )} - 1 )}{{I}_{h} ( {r}_{0} ; {r}_{m} ) - ( {10}^{0.1 \cdot {γ}_{i} {μ}_{k} \cdot {Δφ}_{dp} ( r )} - 1 ) {I}_{h} ( r ; {r}_{m} )} ;$$

$${I}_{h} ( {r}_{0} ; {r}_{m} ) = 0.46 \cdot {μ}_{k} {\int }_{{r}_{0}}^{{r}_{m}} {{[ {Z}_{h}^{′} ( r ) ]}^{b} [ {Z}_{dr}^{′} ( r ) ]}^{c} dr$$

$${μ}_{k} = f ( b , c ) = b + {k}_{k} \cdot c$$

Step (B) may calculate the differential phase using a following equation.

$${φ}_{dp}^{c \_ ik} ( r ) = 2 {\int }_{{r}_{0}}^{r} \frac{{\hat{α}}_{h \_ ik} ( r )}{{γ}_{i}} ds ; {γ}_{m i n} \leq {γ}_{i} \leq {γ}_{ma x}$$

Step (C) may calculate the (m×n) cost functions from a sum of results of obtaining a difference between each of the (m×n) differential phases calculated at step (B) and the observed differential phase at every observation distance.

Step (C) may calculate a cost function using a following equation.

$${x}_{i , k} = \frac{1}{N} {\sum }_{j = 1}^{N} \vert \frac{( {φ}_{dp} ( {r}_{j} ) - {φ}_{dp}^{{c}_{1 k}} ( {r}_{j} ) ) \cdot {φ}_{dp} ( {r}_{j} )}{{Δφ}_{dp}} \vert$$

Step (D) may calculate the specific differential phase using a horizontal attenuation corresponding to the minimum cost function and a proportion variable of the differential phase and the total horizontal attenuation corresponding to the minimum cost function.

### BRIEF DESCRIPTION OF THE DRAWINGS

FIG. 1 is a block diagram schematically showing a specific differential phase estimation apparatus using dual-polarization variables according to an embodiment of the present invention.

FIG. 2 is a graph showing an example of an observation data that an input unit has received.

FIG. 3 is a block diagram showing a processor according to an embodiment of the present invention.

FIG. 4 is a graph showing another example of an observation data that an input unit has received and an example of a calculated optimum specific differential phase.

FIG. 5 is a flowchart illustrating a method of estimating a specific differential phase using a specific differential phase estimation apparatus according to an embodiment of the present invention.

DESCRIPTION OF SYMBOLS

| 100: Specific differential phase estimation apparatus | |
|---|---|
| 110: Input unit | |
| 120: Memory | 130: Processor |

310: Preprocessing unit
320: Total differential phase calculation unit
330: Horizontal attenuation calculation unit
340: Differential phase calculation unit
350: Cost function calculation unit
360: Specific differential phase calculation unit

### DETAILED DESCRIPTION OF THE PREFERRED EMBODIMENT

The objects, other objects, features and advantages of the present invention can be easily understood through the following preferred embodiments related the accompanying drawings. However, the present invention is not limited to the embodiments described herein and may be embodied in other forms. Rather, the embodiments introduced herein are provided to make the content disclosed herein thorough and complete and to fully convey the scope of the present invention to those skilled in the art.

In addition, when it is mentioned that a first element (constitutional component) operates or is executed on a second element (constitutional component), it should be understood such that the element (constitutional component) operates or is executed in an environment in which the second element (constitutional component) operates or is executed or the element (constitutional component) operates or is executed directly or indirectly, through an interaction.

If it is mentioned that an element, a constitutional component, a device or a system includes a constitutional component configured of a program or software, it should be understood such that although it is not mentioned explicitly, the element, the constitutional component, the device or the system includes hardware (e.g., a memory, a CPU, etc.), other programs or software (e.g., an operating system, a driver needed for driving the hardware, etc.) needed for executing or operating the program or the software

In addition, if it is not specially mentioned in implementing an element (or constitutional component), it should be understood such that the element (or constitutional component) may be implemented in any form of software, hardware, or software and hardware.

In addition, the terms used in this specification are for the purpose of describing the embodiments and are not intended to limit the present invention. In this specification, singular forms include plural forms as well, unless the context clearly indicates otherwise. The terms “comprises” and/or “comprising” used in this specification mean that a constitutional element does not preclude the presence or addition of one or more other constitutional elements.

Hereinafter, the present invention will be described in detail with reference to the accompanying drawings. In describing the specific embodiments below, various specific contents are disclosed to describe the present invention more specifically and to help understanding of the present invention. However, those skilled in the art may recognize that the present invention may be used without these various specific contents.

It is mentioned in advance that, in some cases, the parts well-known in describing an invention and not greatly related to the invention are not described to avoid confusion generated without a particular reason.

Hereinafter, specific technical contents to be embodied in the present invention will be described in detail with reference to the accompanying drawings.

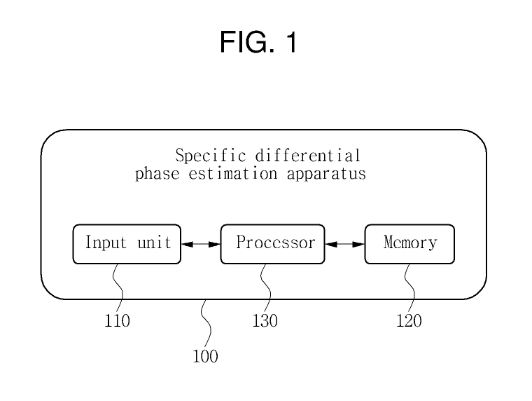

Those skilled in the art may easily infer that configurations of a specific differential phase estimation apparatus 100 using dual-polarization variables as shown in FIG. 1 may be functionally and logically separated and it does not mean that each configuration should be distinguished as a separate physical device or created as a separate code.

Furthermore, the specific differential phase estimation apparatus 100 using dual-polarization variables may be installed in a certain data processing apparatus to implement the spirit of the present invention.

In addition, the specific differential phase estimation apparatus 100 using dual-polarization variables may be one among all electronic devices that can install and execute a program, such as a desktop personal computer (PC), a server, a laptop PC, a netbook computer and the like, or may be implemented in any one of the electronic devices.

FIG. 1 is a block diagram schematically showing a specific differential phase estimation apparatus 100 using dual-polarization variables according to an embodiment of the present invention.

Referring to FIG. 1, the specific differential phase estimation apparatus 100 using dual-polarization variables according to an embodiment of the present invention may include an input unit 110, a memory 120, and a processor 130.

The input unit 110 may receive a plurality of dual-polarization variables including an observed horizontal reflectivity Zₕ(r), an observed differential reflectivity Z_{dr}(r), and an observed differential phase ϕ_{dp}(r) as observation data of a dual-polarization radar (not shown).

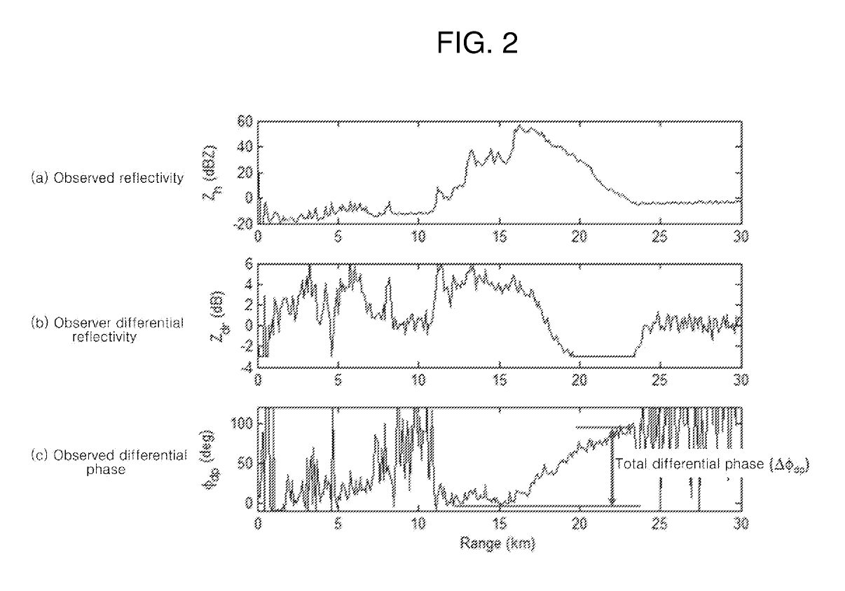

FIG. 2 is a graph showing an example of an observation data that an input unit 110 has received.

FIG. 2(a) shows a ray profile of an observed horizontal reflectivity, FIG. 2(b) shows a ray profile of an observed differential reflectivity, and FIG. 2(c) shows a ray profile of an observed differential phase.

The memory 120 may include volatile memory and/or non-volatile memory. The memory 120 may store commands or data related to constitutional components, one or more programs and/or software, an operating system and the like to implement and/or provide operations, functions or the like provided by the specific differential phase estimation apparatus 100.

The program stored in the memory 120 may include a specific differential phase estimation program for estimating a specific differential phase using dual-polarization variables of the observation data received from the dual-polarization radar (not shown) and the self-consistent calculation method. The specific differential phase estimation program may be implemented to include one or more modules.

For example, modules for implementing operations of a preprocessing unit 310, a total differential phase calculation unit 320, a horizontal attenuation calculation unit 330, a differential phase calculation unit 340, a cost function calculation unit 350, and a specific differential phase calculation unit 360 may be stored in the memory 120, or a module for implementing the operation of the preprocessing unit 310 and a module for implementing the operation of the other constitutional components 320 to 360 may be separately stored in the memory 120, or one module for implementing the operations of these constitutional components 310 to 360 may be stored in the memory 120.

The processor 130 controls general operation of the electronic device 200 by executing one or more programs stored in the specific differential phase estimation apparatus 100.

For example, the processor 130 calculates a plurality of horizontal attenuations using an observed horizontal reflectivity Zₕ(r), an observed differential reflectivity Z_{dr}(r), and an observed differential phase ϕ_{dp}(r) received as observation data by executing the specific differential phase estimation program stored in the memory 120, i.e., by executing commands of the program. That is, after calculating (m×n) horizontal attenuations \hat{α}ₕ_{_}ᵢₖ(r) considering m proportion variables γᵢ of a differential phase and a total horizontal attenuation, and n kappa variables k of the differential phase and a total differential attenuation, calculating (m×n) differential phases using the calculated (m×n) horizontal attenuations, and calculating a cost function including a difference between each of the calculated (m×n) differential phases and the observed differential phase for each of the (m×n) differential phases, the processor 130 may calculate a specific differential phase using a horizontal attenuation corresponding to a minimum cost function among the calculated (m×n) cost functions, and a proportion variable corresponding to the minimum cost function.

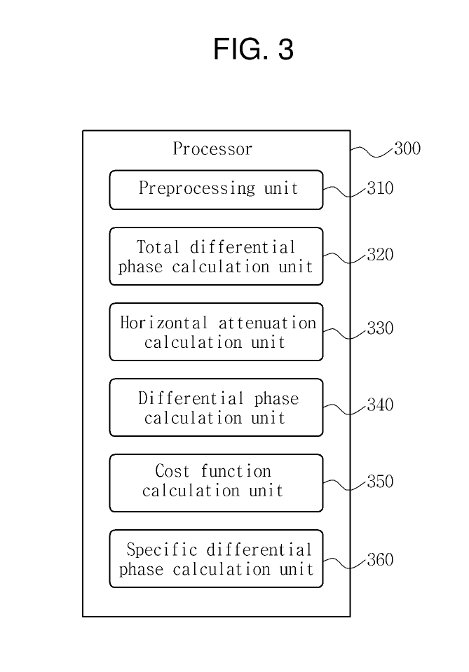

FIG. 3 is a block diagram showing a processor 130 according to an embodiment of the present invention.

Referring to FIG. 3, the processor 130 may include a preprocessing unit 310, a total differential phase calculation unit 320, a horizontal attenuation calculation unit 330, a differential phase calculation unit 340, a cost function calculation unit 350, and a specific differential phase calculation unit 360.

The preprocessing unit 310 reduces signal variation by smoothing the observation data received from the input unit 110, i.e., the observed horizontal reflectivity Zₕ(r), the observed differential reflectivity Z_{dr}(r), and the observed differential phase ϕ_{dp}(r), and may perform a quality processing process by removing bad data having a large signal variation and a low signal-to-noise ratio.

The total differential phase calculation unit 320 may calculate a difference of differential phase between a rainfall start point r₀ and a rainfall end point rₘ from the observed differential phase ϕ_{dp}(r) among the quality processed observation data received from the preprocessing unit 310 as a total differential phase Δϕ_{dp}(r).

Referring to FIG. 2(c), the total differential phase calculation unit 320 may determine a point around 15 Km as the start point and a point around 22.5 km as the end point and calculate a difference of the observed differential phases between the two points as the total differential phase Δϕ_{dp}(r).

The horizontal attenuation calculation unit 330 calculates a plurality of horizontal attenuations using the quality processed observation data, i.e., the observed horizontal reflectivity Z′ₕ(r), the observed differential reflectivity Z′_{dr}(r), and the calculated total differential phase Δϕ_{dp}(r), in which (m×n) horizontal attenuations \hat{α}ₕ_{_}ᵢₖ(r) may be calculated considering m proportion variables γ of the differential phase and the total horizontal attenuation, and n kappa variables k of the differential phase and the total differential attenuation.

The horizontal attenuation calculation unit 330 may calculate horizontal attenuations using [Equation 1].

$${\hat{α}}_{h \_ ik} ( r ) = \frac{{{[ {Z}_{h}^{′} ( r ) ]}^{b} [ {Z}_{dr}^{′} ( r ) ]}^{c} ( {10}^{0.1 \cdot {γ}_{i} {μ}_{k} \cdot {Δφ}_{dp} ( r )} - 1 )}{{I}_{h} ( {r}_{0} ; {r}_{m} ) - ( {10}^{0.1 \cdot {γ}_{i} {μ}_{k} \cdot {Δφ}_{dp} ( r )} - 1 ) {I}_{h} ( r ; {r}_{m} )} ; \\ {I}_{h} ( {r}_{0} ; {r}_{m} ) = 0.46 \cdot {μ}_{k} {\int }_{{r}_{0}}^{{r}_{m}} {{[ {Z}_{h}^{′} ( r ) ]}^{b} [ {Z}_{dr}^{′} ( r ) ]}^{c} dr \\ {μ}_{k} = f ( b , c ) = b + {k}_{k} \cdot c \qquad [ Equation 1 ]$$

γ₁≤γᵢ≤γₘ, γₗ=minimum value of γ, γₘ=maximum value of γ

μ₁≤μₖ≤μₙ, μₗ=minimum value of μ, μₕ=maximum value of μ

In Equation 1, i and k are indexes of m proportion variables γᵢ and n proportion variables μₖ respectively, \hat{α}ₕ_{_}ᵢₖ(r) is a horizontal attenuation calculated for indexes i and k among the (m×n) proportion variables, Z′ₕ(r) is an observed horizontal reflectivity, Z′_{dr}(r) is an observed differential reflectivity, ϕ_{dp}(r) is an observed differential phase, and Δϕ_{dp}(r) is a total differential phase. When i and k are expressed as an equation or a matrix in the present invention, they are expressed as ‘ik’ or ‘i,k’.

In addition, γᵢ is a proportion variable of the differential phase and the total horizontal attenuation, μₖ is a proportion variable determined by a kappa variable k and parameter constants (b, c), the parameter constants (b, c) are constants according to a radar frequency, r₀ is a rainfall start point, and rₘ is a rainfall end point. The kappa variable k may be a proportion variable expressing statistical reliability of the differential phase and the total differential attenuation.

In an embodiment of the present invention, the range of the proportion variables γᵢ and μₖ is defined by the frequency of the dual-polarization radar (not shown), and if the frequency increases, the start value and the end value of the proportion variables are changed. Generally, if the frequency increases, the start value and the end value of the proportion variables are increased. A range of the proportion variables γᵢ and μₖ may be defined as shown below.

γ₁≤γᵢ≤γₘ, γₗ=minimum value of γ, γₘ=maximum value of γ

μ₁≤μₖ≤μₙ, μₗ=minimum value of μ, μₕ=maximum value of μ

Each of the proportion variables γᵢ and μₖ defined as described above may have a step set to be independent from the others so that its value may change independently. Accordingly, the proportion variables γᵢ and μₖ may have one or more values according to the set step within the range defined for the proportion variables γᵢ and μₖ.

That is, proportion variable γᵢ has a step defined to repeat m times within the defined range, and proportion variable μₖ has a step defined to repeat n times within the defined range.

Accordingly, it may be that 0<i<m+1 and 0<k<n+1, and i and k, which are repetition indexes of the proportion variables, are expressed as an integer. When i and k are set to repeat as many times as m and n in maximum respectively, the proportion variables (γᵢ, μₖ) for calculating the horizontal attenuation may be defined as shown below.

$$[ \begin{matrix}{γ}_{1} {μ}_{1} & … & {γ}_{1} {μ}_{n} \\ ⋮ & ⋱ & ⋮ \\ {γ}_{m} {μ}_{1} & … & {γ}_{m} {μ}_{n}\end{matrix} ]$$

For example, if the range of the proportion variable γᵢ is γ₁≤γᵢ≤γₘ=0.2≤γᵢ≤0.3 and the repetition step is 0.1, the proportion variable γᵢ may be as shown in Table 1.

TABLE 1

Index, i

| | 1 | 2 |
|---|---|---|
| γᵢ | 0.2 | 0.3 |

In addition, if the range of the proportion variable μₖ is μ₁≤μₖ≤μₙ=0.3≤μₖ≤0.5 and the repetition step is 0.05, the proportion variable μₖ may be as shown in Table 2.

TABLE 2

| | Index, k | | | | |
|---|---|---|---|---|---|
| | 1 | 2 | 3 | 4 | 5 |
| μₖ | 0.3 | 0.35 | 0.4 | 0.45 | 0.5 |

Since m and n are 2 and 5, respectively, in Table 1 and Table 2, i has indexes of 1 and 2, and k has indexes of 1 to 5. Accordingly, if ten proportion variables (γᵢ,μₖ) according to the combination of the repetition indexes i and k are defined with reference to Table 1 and Table 2, it is as shown below.

$$[ \begin{matrix}{γ}_{1} {μ}_{1} & {γ}_{1} {μ}_{2} & {γ}_{1} {μ}_{3} & {γ}_{1} {μ}_{4} & {γ}_{1} {μ}_{5} \\ {γ}_{2} {μ}_{1} & {γ}_{2} {μ}_{2} & {γ}_{2} {μ}_{3} & {γ}_{2} {μ}_{4} & {γ}_{2} {μ}_{5}\end{matrix} ] = [ \begin{matrix}( 0.2 \; 0.3 ) & ( 0.2 \; 0.35 ) & ( 0.2 \; 0.4 ) & ( 0.2 \; 0.45 ) & ( 0.2 \; 0.5 ) \\ ( 0.3 \; 0.3 ) & ( 0.3 \; 0.35 ) & ( 0.3 \; 0.4 ) & ( 0.3 \; 0.45 ) & ( 0.3 \; 0.5 )\end{matrix} ]$$

The proportion variables (γᵢ, μₖ) like this may be defined in advance considering the parameter constants and the kappa variable according to a radar frequency.

Accordingly, the horizontal attenuation calculation unit 330 may calculate horizontal attenuations for ten proportion variables by substituting each of the ten (m×n=2×5=10) proportion variables (γᵢ,μₖ) in Equation 1.

Meanwhile, the differential phase calculation unit 340 may calculate differential phases using Equation 2 shown below.

$${φ}_{dp}^{c \_ ik} ( r ) = 2 {\int }_{{r}_{0}}^{r} \frac{{\hat{α}}_{h \_ ik} ( r )}{{γ}_{i}} ds ; {γ}_{m i n} \leq {γ}_{i} \leq {γ}_{ma x} \qquad [ Equation 2 ]$$

In Equation 2, i and k are indexes of the m proportion variables and n proportion variables respectively, ϕ_{dp}^{c}^{_}^{ik}(r) is a differential phase calculated at indexes i and k among the (m×n) proportion variables, and γᵢ is the i-th proportion variable among the m proportion variables.

Referring to Equation 2, the differential phase calculation unit 340 may calculate (m×n) differential phases ϕ_{dp}^{c}^{_}^{ik}(r) using (m×n) horizontal attenuations αₕ_{_}ᵢₖ(r), which is calculated for each index of the proportion variables using Equation 1, and the proportion variable γᵢ.

The cost function calculation unit 350 may calculate a cost function including a difference between each of the (m×n) differential phases ϕ_{dp}^{c}^{_}^{ik}(r) calculated by the differential phase calculation unit 340 and the observed differential phase ϕ_{dp}(r) for each of the (m×n) differential phases.

If the differential phases of all the proportion variables, i.e., (m×n) differential phases, are calculated, the cost function calculation unit 350 may calculate cost functions using Equation 3 shown below.

$${x}_{1 , 1} = \frac{1}{N} {\sum }_{j = 1}^{N} \vert \frac{( {φ}_{dp} ( {r}_{j} ) - {φ}_{dp}^{{c}_{11}} ( {r}_{j} ) ) \cdot {φ}_{dp} ( {r}_{j} )}{{Δφ}_{dp}} \vert ; \\ {x}_{i , k} = \frac{1}{N} {\sum }_{j = 1}^{N} \vert \frac{( {φ}_{dp} ( {r}_{j} ) - {φ}_{dp}^{{c}_{1 k}} ( {r}_{j} ) ) \cdot {φ}_{dp} ( {r}_{j} )}{{Δφ}_{dp}} \vert ; \\ {x}_{m , n} = \frac{1}{N} {\sum }_{j = 1}^{N} \vert \frac{( {φ}_{dp} ( {r}_{j} ) - {φ}_{dp}^{{c}_{mn}} ( {r}_{j} ) ) \cdot {φ}_{dp} ( {r}_{j} )}{{Δφ}_{dp}} \vert ; \qquad [ Equation 3 ]$$

In Equation 3, i and k are indexes of m proportion variables and n proportion variables respectively, X_{i,k} is a cost function calculated at indexes i and k among (m×n) proportion variables, j is an index of an observation distance, γⱼ is an observation distance, ϕ_{dp}(rⱼ) is a differential phase observed at j, and ϕ_{dp}^{c}^{ᵢₖ}(rⱼ) is a differential phase calculated at j. N is the maximum number of distances observed in the total observation distance range. For example, if the total observation distance range is 10 to 20 km and the observation step is 1 km, it means observation of every 1 km, and N may be 10 or 11 according to setting of a user.

Referring to Equation 3, the cost function calculation unit 350 may obtain a difference between each of the (m×n) differential phases ϕ_{dp}^{c}^{ᵢₖ}(rⱼ) calculated by the cost function calculation unit 350 and the observed differential phase ϕ_{dp}(rⱼ) at every observation distance, and calculate (m×n) cost functions from a sum of results obtained at every observation distance. That is, the cost function calculation unit 350 may calculate (m×n) cost functions corresponding to the repetition indexes i and k, and this can be expressed as a matrix shown below.

$$[ \begin{matrix}{X}_{1 , 1} & … & {X}_{1 , n} \\ ⋮ & ⋱ & ⋮ \\ {X}_{m , 1} & … & {X}_{m , n}\end{matrix} ]$$

Meanwhile, the specific differential phase calculation unit 360 may calculate a specific differential phase using the horizontal attenuation corresponding to a minimum cost function among the (m×n) cost functions calculated by the cost function calculation unit 350, and the proportion variable corresponding to the minimum cost function. This is since that the minimum cost function means a differential phase, the difference of which from the observed differential phase is smallest, among the (m×n) differential phases calculated by the cost function calculation unit 350 and therefore means that they are most similar to each other.

The specific differential phase calculation unit 360 may confirm the horizontal attenuations \hat{α}ₕ_{_}ᵢₖ(r) used for calculating the minimum cost function and the proportion variable γⱼ of the differential phase and the total horizontal attenuation, and calculate an optimum specific differential phase using Equation 4 shown below.

$$[ {K}_{dp} ( r ) = \frac{{\hat{α}}_{h \_ ik} ( r )}{{γ}_{i}} ] \qquad [ Equation 4 ]$$

Referring to Equation 4, the specific differential phase calculation unit 360 may calculate the specific differential phase using the horizontal attenuations \hat{α}ₕ_{_}ᵢₖ(r) and the proportion variable γⱼ corresponding to the confirmed minimum cost function.

For example, if the minimum cost function is X_{3,4} among the (m×n) cost functions

$$[ \begin{matrix}{X}_{1 , 1} & … & {X}_{1 , n} \\ ⋮ & ⋱ & ⋮ \\ {X}_{m , 1} & … & {X}_{m , n}\end{matrix} ] ,$$

the specific differential phase calculation unit 360 may calculate an optimum specific differential phase as shown in Equation 5 by substituting the horizontal attenuation \hat{α}ₕ_{_}₃₄(r) used for calculating the minimum cost function X_{3,4} and the proportion variable γ₃ into Equation 4.

$${K}_{dp} ( r ) = \frac{{\hat{α}}_{h \_ 34} ( r )}{{γ}_{3}} \qquad [ Equation 5 ]$$

The calculated optimum specific differential phase can be used for calculating precipitation, i.e., for predicting rainfall.

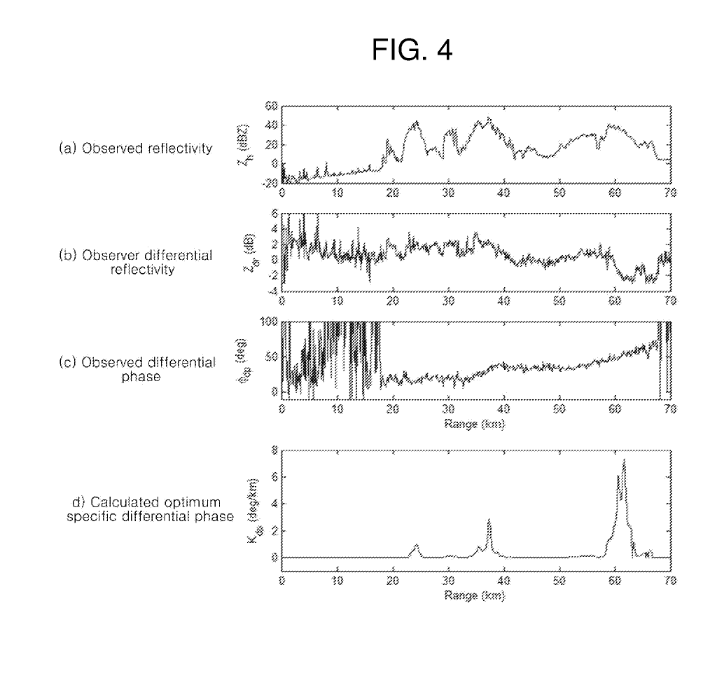

FIG. 4 is a graph showing another example of an observation data that an input unit 110 has received and an example of a calculated optimum specific differential phase.

Referring to FIG. 4, for example, the specific differential phase calculated considering the differential phase observed at an observation distance between 30 km and 68 km does not have a negative differential phase value, and the problem of underestimating the peak value is solved, and although it is not shown, the back scattering is also removed.

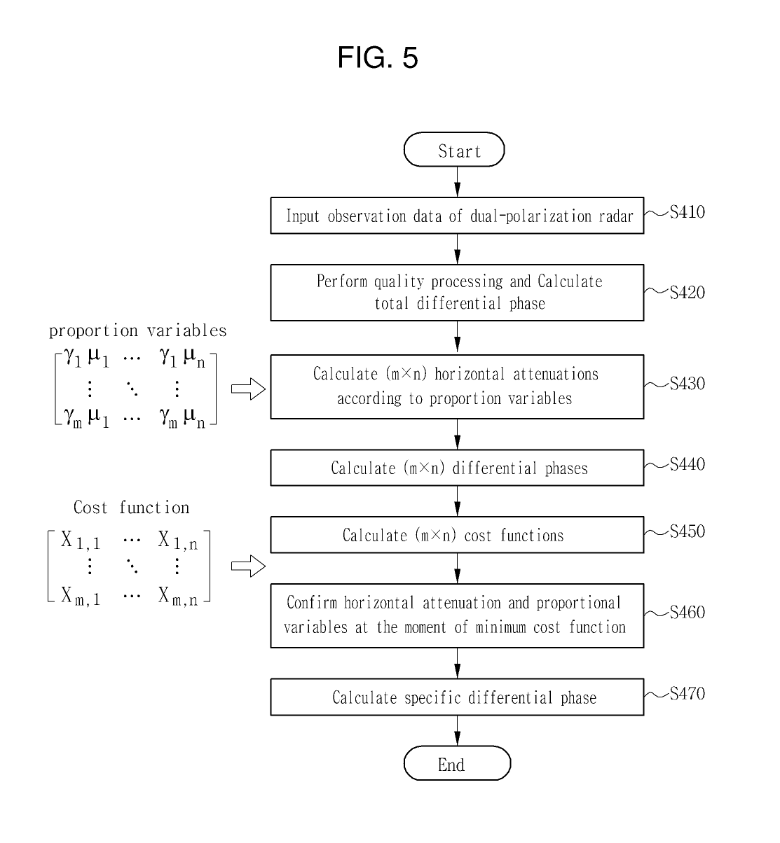

FIG. 5 is a flowchart illustrating a method of estimating a specific differential phase using a specific differential phase estimation apparatus 100 according to an embodiment of the present invention.

Since the specific differential phase estimation method of FIG. 5 can be implemented by the specific differential phase estimation apparatus 100 described with reference to FIGS. 1 to 4, detailed description is omitted.

Referring to FIG. 5, the specific differential phase estimation apparatus 100 receives a plurality of dual-polarization variables including an observed horizontal reflectivity Zₕ(r), an observed differential reflectivity Z_{dr}(r), and an observed differential phase ϕ_{dp}(r) as observation data of a dual-polarization radar (not shown) (step S410).

The specific differential phase estimation apparatus 100 may reduce signal variation by smoothing the received observation data, perform a quality processing process by removing bad data having a large signal variation and a low signal-to-noise ratio, and calculate a difference of differential phase between a rainfall start point r₀ and a rainfall end point rₘ from the observed differential phase among the quality processed observation data as a total differential phase Δϕ_{dp}(r).

The specific differential phase estimation apparatus 100 may calculate a plurality of horizontal attenuations using the quality processed observation data, i.e., the observed horizontal reflectivity, the observed differential reflectivity, and the total differential phase calculated at step S420, in which (m×n) horizontal attenuations \hat{α}ₕ_{_}ᵢₖ(r) may be calculated considering m proportion variables γᵢ of the differential phase and the total horizontal attenuation and n kappa variables k of the differential phase and the total differential attenuation. Step S430 may be calculated as shown in Equation 1.

The specific differential phase estimation apparatus 100 may calculate (m×n) differential phases using the (m×n) horizontal attenuations calculated for each index of the proportion variables at step S430 and the proportion variables (step S440). Step S440 may be calculated as shown in Equation 2.

In addition, the specific differential phase estimation apparatus 100 may calculate a cost function including a difference between each of the (m×n) differential phases calculated at step S440 and the observed differential phase for each of the (m×n) differential phases (step S450). Step S450 may be calculated as shown in Equation 3.

The specific differential phase estimation apparatus 100 may confirm a horizontal attenuation corresponding to a minimum cost function among the (m×n) cost functions calculated at step S450, and a proportion variable corresponding to the minimum cost function (step S460), and calculate an optimum specific differential phase using the confirmed horizontal attenuation used for calculating the minimum cost function, and the confirmed proportion variable of the differential phase and the total horizontal attenuation (step S470). Step S470 may be calculated as shown in Equation 4.

Meanwhile, those skilled in the art may easily understand that the method of estimating a specific differential phase using dual-polarization variables of the specific differential phase estimation apparatus 100 according to the present invention can be provided in a recording medium that can be read through a computer as a program of commands for implementing the method is tangibly implemented.

That is, the method of estimating a specific differential phase using dual-propagation variables of the specific differential phase estimation apparatus 100 according to the present invention may be implemented in the form of a program that can be performed through various computing means and recorded in a computer-readable recording medium, and the computer-readable recording medium may include program commands, data files, data structures and the like independently or in combination. The computer-readable recording medium includes magnetic media such as a hard disk, optical media such as CD-ROM and DVD, and hardware devices specially configured to store and perform program commands, such as ROM, RAM, flash memory, USB memory and the like.

Accordingly, the present invention also provides programs stored in the computer-readable recording medium executed on a computer which controls the specific differential phase estimation apparatus 100, to implement the method of estimating a specific differential phase using dual-polarizations of the specific differential phase estimation apparatus 100.

According to the present invention, there is an effect of estimating precipitation more accurately by estimating an optimum specific differential phase on the basis of a self-consistent method using dual-polarization variables, instead of the existing filtering method, on hydrometeor such as rainfall.

In addition, according to the present invention, the problem of underestimating a peak value generated when an existing filtering method is applied can be solved, and the back scattering can be removed, and furthermore, the problem of misestimating a specific differential phase as a negative value can be solved.

In addition, according to the present invention, the specific differential phase estimation apparatus is almost not affected by the bias effect of a radar system, which gives an influence to the observed reflectivity and differential reflectivity, and is not much sensitive to variation of a temperature and rainfall model (drop size distribution, DSD).

In addition, according to the present invention, since a further better convergence is conducted to estimate an optimum specific differential phase, accuracy of calculating the specific differential phase can be enhanced considerably.

The effects of the present invention are not limited to those mentioned above, and unmentioned other effects may be clearly understood by those skilled in the art from the following descriptions.

Meanwhile, although the preferred embodiments for exemplifying the spirit of the present invention have been described above, the present invention is not limited to the configuration and operation as is described and shown like this, and those skilled in the art may easily understand that a plurality of modifications and changes can be made on the present invention without departing from the spirit of the present invention. Accordingly, all the proper modifications, changes and equivalents should be considered as falling within the scope of the present invention. Accordingly, the true scope of the present invention should be defined by the spirit of the appended claims.

What is claimed is:

1. A specific differential phase estimation apparatus using dual-polarization variables, the apparatus comprising:
a memory for storing a specific differential phase estimation program for estimating a specific differential phase using the dual-polarization variables of an observation data received from a dual-polarization radar and a self-consistent calculation method; and
a processor including:
a horizontal attenuation calculation unit for calculating a plurality of horizontal attenuations \hat{α}ₕ_{_}ᵢₖ(r) using an observed horizontal reflectivity Zₕ(r), an observed differential reflectivity Z_{dr}(r), and an observed differential phase ϕ_{dp}(r) received as observation data by executing the specific differential phase estimation program stored in the memory;
a differential phase calculation unit for calculating (m×n) differential phases using the calculated (m×n) horizontal attenuations;
a cost function calculation unit for calculating a cost function including a difference between each of the calculated (m×n) differential phases and the observed differential phase for each of the (m×n) differential phases; and
a specific differential phase calculation unit for calculating the specific differential phase using a horizontal attenuation corresponding to a minimum cost function among the calculated (m×n) cost functions, and a proportion variable corresponding to the minimum cost function,
wherein the horizontal attenuation calculation unit calculates (m×n) horizontal attenuations \hat{α}ₕ_{_}ᵢₖ(r) considering m proportion variables γᵢ of a differential phase and a total horizontal attenuation, and n kappa variables k of the differential phase and a total differential attenuation.

2. The apparatus according to claim 1, wherein the processor further includes a total differential phase calculation unit for calculating a difference of differential phase between a rainfall start point r₀ and a rainfall end point rₘ from the observed differential phase as a total differential phase Δϕ_{dp}(r), and the horizontal attenuation calculation unit calculates the (m×n) horizontal attenuations using the observed horizontal reflectivity, the observed differential reflectivity, and the calculated total differential phase.

3. The apparatus according to claim 2, wherein the horizontal attenuation calculation unit calculates the horizontal attenuations using a following equation
$${\hat{α}}_{h \_ ik} ( r ) = \frac{{{[ {Z}_{h}^{′} ( r ) ]}^{b} [ {Z}_{dr}^{′} ( r ) ]}^{c} ( {10}^{0.1 \cdot {γ}_{i} {μ}_{k} \cdot {Δφ}_{dp} ( r )} - 1 )}{{I}_{h} ( {r}_{0} ; {r}_{m} ) - ( {10}^{0.1 \cdot {γ}_{i} {μ}_{k} \cdot {Δφ}_{dp} ( r )} - 1 ) {I}_{h} ( r ; {r}_{m} )} ;$$
$${I}_{h} ( {r}_{0} ; {r}_{m} ) = 0.46 \cdot {μ}_{k} {\int }_{{r}_{0}}^{{r}_{m}} {{[ {Z}_{h}^{′} ( r ) ]}^{b} [ {Z}_{dr}^{′} ( r ) ]}^{c} dr$$
$${μ}_{k} = f ( b , c ) = b + {k}_{k} \cdot c ,$$
here
i and k are indexes of the m proportion variables γᵢ and n proportion variables μₖ respectively, \hat{α}ₕ_{_}ᵢₖ(r) is a horizontal attenuation calculated for indexes i and k among (m×n) proportion variables, Z′ₕ(r) is an observed horizontal reflectivity, Z′_{dr}(r) is an observed differential reflectivity, ϕ_{dp}(r) is an observed differential phase, and Δϕ_{dp}(r) is a total differential phase, γᵢ is a proportion variable of a differential phase and a total horizontal attenuation, μₖ is a proportion variable determined by a kappa variable and a constant according to a radar frequency, r₀ is a rainfall start point, and rₘ is a rainfall end point.

4. The apparatus according to claim 1, wherein the differential phase calculation unit calculates the differential phase using a following equation
$${φ}_{dp}^{c \_ ik} ( r ) = 2 {\int }_{{r}_{0}}^{r} \frac{{\hat{α}}_{h \_ ik} ( r )}{{γ}_{i}} ds ; {γ}_{m i n} \leq {γ}_{i} \leq {γ}_{ma x} ,$$
here
i and k are indexes of the m proportion variables and n proportion variables respectively, ϕ_{dp}^{c}^{_}^{ik}(r) is a differential phase calculated at indexes i and k among the (m×n) proportion variables, and γᵢ is an i-th proportion variable among the m proportion variables.

5. The apparatus according to claim 1, wherein the cost function calculation unit calculates the (m×n) cost functions from a sum of results of obtaining a difference between each of the calculated (m×n) differential phases and the observed differential phase at every observation distance.

6. The apparatus according to claim 5, wherein the cost function calculation unit calculates a cost function using a following equation
$${x}_{i , k} = \frac{1}{N} {\sum }_{j = 1}^{N} \vert \frac{( {φ}_{dp} ( {r}_{j} ) - {φ}_{dp}^{{c}_{1 k}} ( {r}_{j} ) ) \cdot {φ}_{dp} ( {r}_{j} )}{{Δφ}_{dp}} \vert ,$$
here
i and k are indexes of the m proportion variables and n proportion variables respectively, X_{i,k} is a cost function at indexes i and k among the (m×n) proportion variables, j is an index of an observation distance, γⱼ is an observation distance, ϕ_{dp}(rⱼ) is a differential phase observed at j, and ϕ_{dp}(rⱼ) is a differential phase calculated at j.

7. The apparatus according to claim 1, wherein the specific differential phase calculation unit calculates the specific differential phase using a horizontal attenuation corresponding to the minimum cost function and a proportion variable of the differential phase and the total horizontal attenuation corresponding to the minimum cost function.

8. A method of estimating a specific differential phase using specific differential variables of a specific differential phase estimation apparatus, the method comprising the steps of:
(A) calculating a plurality of horizontal attenuations using an observed horizontal reflectivity Zₕ(r), an observed differential reflectivity Z_{dr}(r), and an observed differential phase ϕ_{dp}(r) inputted as observation data of a dual-polarization radar;
(B) calculating (m×n) differential phases using the calculated (m×n) horizontal attenuations;
(C) calculating a cost function including a difference between each of the calculated (m×n) differential phases and the observed differential phase for each of the (m×n) differential phases; and
(D) calculating a specific differential phase using a horizontal attenuation, corresponding to a minimum cost function among the calculated (m×n) cost functions, and a proportion variable corresponding to the minimum cost function,
wherein step (A) calculates (m×n) horizontal attenuations \hat{α}ₕ_{_}ᵢₖ(r) considering m proportion variables γᵢ of a differential phase and a total horizontal attenuation, and n kappa variables k of the differential phase and a total differential attenuation.

9. The method according to claim 8, wherein step (A) includes the steps of:
(A1) receiving the observed horizontal reflectivity, the observed differential reflectivity, and the observed differential phase as observation data of the dual-polarization radar;
(A2) calculating a difference of differential phase between a rainfall start point r₀ and a rainfall end point rₘ from the observed differential phase as a total differential phase Δϕ_{dp}(r); and
(A3) calculating the (m×n) horizontal attenuations using the observed horizontal reflectivity, the observed differential reflectivity, and the total differential phase.

10. The method according to claim 9, wherein step (A3) calculates the horizontal attenuations using a following equation
$${\hat{α}}_{h \_ ik} ( r ) = \frac{{{[ {Z}_{h}^{′} ( r ) ]}^{b} [ {Z}_{dr}^{′} ( r ) ]}^{c} ( {10}^{0.1 \cdot {γ}_{i} {μ}_{k} \cdot {Δφ}_{dp} ( r )} - 1 )}{{I}_{h} ( {r}_{0} ; {r}_{m} ) - ( {10}^{0.1 \cdot {γ}_{i} {μ}_{k} \cdot {Δφ}_{dp} ( r )} - 1 ) {I}_{h} ( r ; {r}_{m} )} ;$$
$${I}_{h} ( {r}_{0} ; {r}_{m} ) = 0.46 \cdot {μ}_{k} {\int }_{{r}_{0}}^{{r}_{m}} {{[ {Z}_{h}^{′} ( r ) ]}^{b} [ {Z}_{dr}^{′} ( r ) ]}^{c} dr$$
$${μ}_{k} = f ( b , c ) = b + {k}_{k} \cdot c ,$$
here
i and k are indexes of the m proportion variables γᵢ and n proportion variables μₖ respectively, \hat{α}ₕ_{_}ᵢₖ(r) is a horizontal attenuation calculated for indexes i and k among (m×n) proportion variables, Z′ₕ(r) is an observed horizontal reflectivity, Z′_{dr}(r) is an observed differential reflectivity, ϕ_{dp}(r) is an observed differential phase, and Δϕ_{dp}(r) is a total differential phase,
γᵢ is a proportion variable of a differential phase and a total horizontal attenuation, μₖ is a proportion variable determined by a kappa variable and a constant according to a radar frequency, r₀ is a rainfall start point, and rₘ is a rainfall end point.

11. The method according to claim 8, wherein step (B) calculates the differential phase using a following equation
$${φ}_{dp}^{c \_ ik} ( r ) = 2 {\int }_{{r}_{0}}^{r} \frac{{\hat{α}}_{h \_ ik} ( r )}{{γ}_{i}} ds ; {γ}_{m i n} \leq {γ}_{i} \leq {γ}_{ma x} ,$$
here
i and k are indexes of the m proportion variables and n proportion variables respectively, ϕ_{dp}^{c}^{_}^{ik}(r) is a differential phase calculated at indexes i and k among the (m×n) proportion variables, and γᵢ is an i-th proportion variable among the m proportion variables.

12. The method according to claim 8, wherein step (C) calculates a cost function using a following equation
$${x}_{i , k} = \frac{1}{N} {\sum }_{j = 1}^{N} \vert \frac{( {φ}_{dp} ( {r}_{j} ) - {φ}_{dp}^{{c}_{1 k}} ( {r}_{j} ) ) \cdot {φ}_{dp} ( {r}_{j} )}{{Δφ}_{dp}} \vert ,$$
here
i and k are indexes of the m proportion variables and n proportion variables respectively, X_{i,k} is a cost function at indexes i and k among the (m×n) proportion variables, j is an index of an observation distance, γⱼ is an observation distance, ϕ_{dp}(rⱼ) is a differential phase observed at j, and ϕ_{dp}^{c}^{ᵢₖ}(rⱼ) is a differential phase calculated at j.

13. The method according to claim 8, wherein step (D) calculates the specific differential phase using a horizontal attenuation corresponding to the minimum cost function and a proportion variable of the differential phase and the total horizontal attenuation corresponding to the minimum cost function.
